(19) United States
(12) Patent Application Publication
(10) Pub. No.: US 2015/0173407 A1
(43) Pub. Date: Jun. 25, 2015

(54) IONICALLY CHARGED NUTRITIONAL SUPPLEMENT, PROCESS OF MAKING AND APPARATUS THEREFORE

(71) Applicant: P-Tech Holdings, Inc., Fort Myers, FL (US)

(72) Inventors: Shawn MUELLER, Fort Myers, FL (US); Kevin THOMAS, Naples, FL (US)

(73) Assignee: P-Tech Holdings, Inc., Fort Myers, FL (US)

(21) Appl. No.: 14/578,974

(22) Filed: Dec. 22, 2014

Related U.S. Application Data
(60) Provisional application No. 61/920,030, filed on Dec. 23, 2013.

(51) Int. Cl. A23L 1/304; C02F 1/68

(52) U.S. Cl. CPC A23L 1/304; C02F 1/68; A23V 2002/00

(57) ABSTRACT

A mineral-containing formulation is taught that is exposed to a magnetic field effective for converting the molecular ion structures of the starting materials to a stable negative polarity charge within the product. A device, in the form of an ionic charge magnetron is taught for enhancing the molecular ion structures of the starting materials to a stable negative polarity charge within the product.

### CROSS-REFERENCE TO RELATED APPLICATIONS

This application claims benefit of priority to U.S. Provisional Patent Application Ser. No. 61/920,030, filed Dec. 23, 2013, the contents of which is incorporated herein by reference in its entirety.

### FIELD OF THE INVENTION

This invention relates to a device for polarization, via use of a static magnetically charged field, of a mixture of mineral elements in order to produce an end product that is effective, in vivo, for promoting nutrient absorption and red blood cell hydration.

### BACKGROUND OF THE INVENTION

Electrolytes are micronutrients that are necessary components of the human diet. Electrolytes are mineral salts, in ionic form. Electrolytes help to maintain voltages across nerve, heart, muscle, and other body cell membranes. Electrolytes also facilitate the transport of electrical impulses, such as nerve impulses and muscle contractions, across nerve and muscle cells, respectively.

It has been previously known (see U.S. Published Application 2011/0086135 to Mueller, et al) to form electrolyte solutions which comprise a fortified liquid composition, comprising purified water, molecular oxygen at a level between 30 and 60 mg/l, and a combination of minerals in that purified water. The minerals include at least 0.002 mg/l boron, at least 0.0001 mg/l chromium, at least 0.045 mg/l cobalt, at least 0.019 mg/l copper, at least 0.086 mg/l iodine, at least 0.053 mg/l manganese, at least 0.36 mg/l potassium. at least 0.0003 mg/l selenium, at least 0.029 mg/l silica, at least 2.61 mg/l sodium, and at least 0.015 mg/l zinc.

The prior art process described in the '135 publication requires a multi-step water purification process, blending of the purified water with minerals, and infusion of the water/mineral blend with oxygen in order to produce the fortified liquid composition as taught therein.

The multi-step water purification. coupled with the oxygen infusion is both costly and time-consuming. If a system could be devised for producing a fortified nutritional supplement which is effective, in vivo, for promoting nutrient absorption and red blood cell hydration, while eliminating one or more of the prior art steps, a long felt need in the art would be realized.

### SUMMARY OF THE INVENTION

The invention is directed toward a mineral-containing formulation that is exposed to a magnetic field effective for converting the molecular ion structures of the starting materials to a stable negative polarity charge within the product.

The water suitable for use in the process may be any water containing less than 2 PPM particulates. Waters suitable for use in the process are illustrated, albeit not limited to reverse osmosis, UV sterilized, deionized, filtered water, and the like. In an embodiment, deionized water is used, since the ions are to be replaced with a select mineral blend to avoid other mineral influences in the process.

Although, in an embodiment, a selection of 11 minerals is exemplified, it is to be understood that the mineral blend can be modified to address multiple health conditions and no specific blend is limited to this process. This process can be applied to any and all mineral contributions based on the intended health application.

The device that exposes the mineral formulation to this charge is also a subject of the instant invention, and is in the form of an Ionic Charge Magnetron (ICM) assembled by aligning a plurality of Super Magnets (exemplified as four Super Magnets). The Super Magnets are aligned with matching polarity at precisely spaced intervals to provide the necessary time in field in the Southern pole alignment configuration to accomplish the desired effect on the mineral or mineral blend. It is understood that the ICM may be used to treat the mineral blend itself prior to dissolution, or the solution containing the mineral blend dissolved in the aqueous carrier fluid may be treated. In either case, the resulting ICM treated mineral solution is effective as a nutrient polarized water formulation or NPW.

The resulting product is useful as a cellular hydration support platform whereby select nutritional mineral elements are compounded and then polarized via the static magnetically charged field.

The product produced by this process is capable of increasing osmotic pressure within the human red blood cell (RBC's) via an electrical chemical exchange; promoting a negative ionic charge to the RBC's through the ionic exchange process upon ingestion (RBC Contact Exposure Influence); and providing nutritional dietary input of select conductive micronutrients in mineral form compounded by their naturally occurring ionic charge.

While not wishing to be bound to any particular theory of operation, processing by use of the Ionic Charge Magnetron (ICM) to form an NPW formulation appears to polarize the mineral or mineral/water blend to sustain and enhance the longevity and cytophilic activity within the RBC. The blending and processing appears to activate nutritional formulations by promoting nutrient absorption and cellular (RBC) hydration.

Traditional non-charged nutrients meet with cellular resistance and absorption challenges. The ICM has no known disadvantages. It is believed that other nutrients may be benefited by the introduction to the ICM.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof

### BRIEF DESCRIPTION OF THE FIGURES

FIG. 1 illustrates an embodiment of an Ionic Charge Magnetron;

FIG. 2A illustrates Pre- and Post-Dosing Micrographs of a blood sample from a 17 year old male patient;

FIG. 2B illustrates Pre- and Post-Dosing Micrographs of a blood sample from a 28 year old male patient;

FIG. 2C illustrates Pre- and Post-Dosing Micrographs of a blood sample from a 49 year old female patient; and

FIG. 2d illustrates Pre- and Post-Dosing Micrographs of a blood sample from a 61 year old male patient.

### DETAILED DESCRIPTION OF THE INVENTION

This invention is susceptible of embodiments in many different forms. The preferred embodiment of the invention is to be considered as but one example of the principles of the invention. The preferred embodiment is not intended to limit the broadest aspect of the invention to the embodiment described in this specification.

### Ionic Charge Magnetron

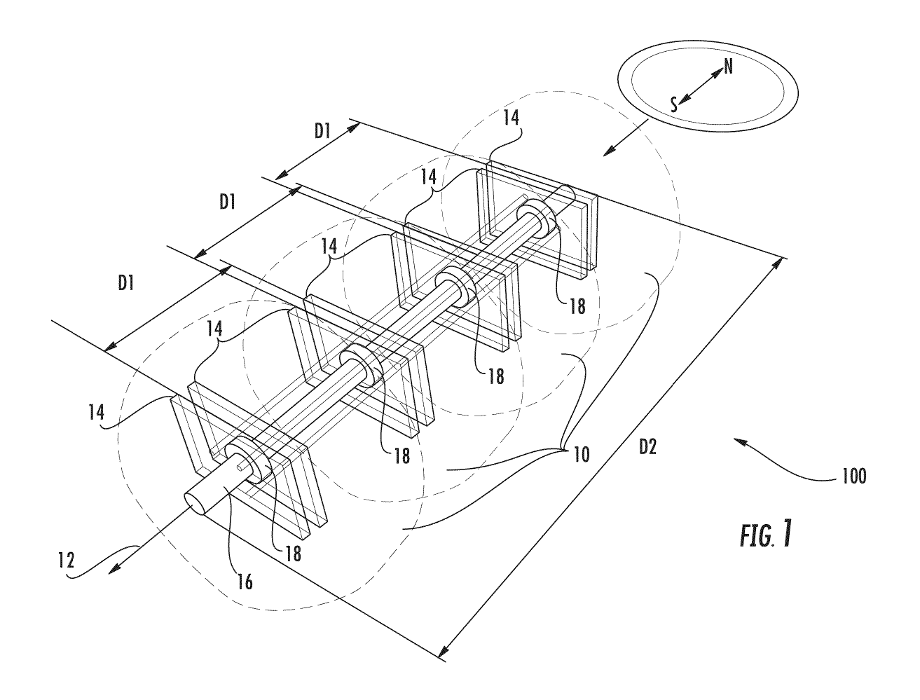

With reference to FIG. 1, an embodiment of the invention is depicted. In this illustrative, albeit non-limiting embodiment, the ionic charge magnetron 100 is illustrated as containing four Neodymium, 60 Nd, Rare Earth Magnets 18. The use of a plurality of magnets, as opposed to one large magnet, has been determined to be necessary in order to maintain a desired exposure time within the magnetic field 10.

These “Super Magnets” 18 are classified as having a field of 30,000 Gauss. In the exemplary embodiment, four (4) of the Super Magnets are assembled in-line, at a separation distance D1 between each magnet of about 13½″ (34.29 cm). Alignment of the four Super Magnets with matching polarity at precisely spaced intervals, in the Southern pole alignment configuration creates conditions to provide the necessary time in field. In this embodiment, an illustrative, albeit non-limiting means for stabilizing the position of the magnets 18 is shown as a pair of stabilizer blocks 14 constructed and arranged to be fixedly and removably engaged about product flow tube 16, which is illustrated as having a length D2 of 48″.

The visual effective field was identified at 10.5″; this was accomplished by presenting light metals (1 gram wire) to the vicinity of the magnet. Once the metal wire started to move (was affected by the field) the distance was measured. The test is repeated on all magnets (all four in the exemplary embodiment) and yielded exacting results. In this illustrative embodiment, the measurement of the visual effective field was 10.5″. That distance represents an outside range of the energy field, the closer to the magnet (i.e. 10.5″), the stronger the energy field. The magnets were distanced by 10.5″ (the active field) to allow a 50% overlap in the magnetic fields 10 to provide field conversion and energy wavelength equality. This enables the avoidance of four separate energy loops and creates one equal magnetic field 10 extending about product flow tube 16.

The material to be treated, e.g. a mineral or mineral blend or an aqueous mineral or mineral blend, flows through product flow tube 16, along longitudinal axis 12. The degree of downward slope is adjusted in the process to achieve the desired dwell or residence time within the magnetic field 10. In this embodiment, the desired dwell time is 2.3 seconds. The exact measurements will depend upon the specific gravity (or weight) of the product sent through the reactor. For example, a 2 oz bottle travels a bit faster than a 1 oz bottle; therefore the angle is adjusted and tested to meet the required dwell time. In the illustrated embodiment, the Influence Saturation Rate (ISR), which is the time of exposure at a particular magnetic field strength sufficient to result in a mineral-containing formulation, which exhibits a stable negative polarity charge, is calculated to be 100% at 2.1 seconds of exposure. The configuration of the ICM provides for a constant field exposure of about 2.3 seconds, thereby insuring complete treatment of the mineral or mineral/water blend.

### Methodology and Process Steps

Components (raw materials or finished goods of nutritional value) are prepared to a specification or formula prior to processing in the reactor. Components (if single compound, blended compounds or finished goods) are passed through the reactor (S to N @45 degrees) maintaining a minimum “dwell” time in the effective field of static magnetic energy 10 to influence the polarity modification and potential alignment. When a stable negative polarity charge has been established, this is indicative of an influence saturation rate of 100%.

The reactor 100 is used in a static, non-grounded insulated workspace environment to shield from static energy grounding or influence.

Finished/Processed product is removed from the Reactor area and packaged for distribution.

In an embodiment, the minerals used are selected from eleven (11) minerals that include copper, iodine, manganese, zinc, potassium, cobalt, sodium, selenium, chromium, silica, and boron, either singly or in any combination thereof

For the purposes of this invention, the minimum amounts in which each of these minerals may be provided are as follows: (a) at least about 0.002 mg/l boron; (b) at least about 0.0001 mg/l chromium; (c) at least about 0.045 mg/l cobalt; (d) at least about 0.019 mg/l copper; (e) at least about 0.086 mg/l iodine; (f) at least about 0.053 mg/l manganese; (g) at least about 0.36 mg/l potassium; (h) at least about 0.0003 mg/l selenium; (i) at least about 0.029 mg/l silica; (j) at least about 2.61 mg/l sodium; and (k) at least about 0.015 mg/l zinc.

It will be understood, however, that these minima are not exact. There is a tolerance in the amounts of these minerals. Particularly, for the purposes of this invention, the minimum amount of boron is 0.002 mg/.+/−0.4%; the minimum amount of chromium is 0.0001 mg/l.+/−0.3%; the minimum amount of cobalt is 0.045 mg/l. +/−0.3%; the minimum amount of copper is 0.019 mg/l.+/−0.5%; the minimum amount of iodine is 0.086 mg/l.+/−0.3%; the minimum amount of manganese is 0.053 mg/1.+/−0.6%; the minimum amount of potassium is 0.36 mg/l.+/−0.7%; the minimum amount of selenium is 0.0003 mg/l.+/−0.3%; the minimum amount of silica is 0.029 mg/l.+/−0.5%; the minimum amount of sodium is 2.61 mg/l.+/−0.7%; and the minimum amount of zinc is 0.015 mg/l.+/−0.3%.

There is no “chemical” change to the processed product, nor is any intended by the device. Resident energy and polarity potential exist in all organic matter, and it is capable of being influenced. The process is not intended to “alter” the structure or function of the nutritional compound.

Rather, although not wishing to be bound to any particular theory of operation, the process appears to enhance the naturally occurring energy and delivery potential of a compound or blend at the cellular level in people.

Aligning and polarizing the magnetic influencable elements of nutritional compounds achieves nutrient polarization.

This polarization promotes a “series” conductivity current pathway (electro and magnetic). Non-polarized matter holds a random conductivity pattern that promotes inefficient energy utilization in the conversion of matter to energy and promotes excess emissions (waste).

The static electro/magnetic charge (−Ion) promoted in the compound (>1/1 m NV (greater than 1 millionth of a nanovolt) up to the level of retained live blood cell current in millivolts) provides “post consumption” ionic charge to all cell surface contacts. This energy exchange reacts in a continuum from oral introduction through blood plasma conductivity.

Mineral compounding to the aqueous solution provides additional biocatalyst matter upon which to influence the magnetic charge, and polarity series sequencing. Additionally, the minerals and micro minerals in static form (as nature provides) provide added nutritional value to the compound.

### Test Validation Of Resulting Biological Effect

Although human electricity, magnetic energy and mineral nutrition are well known to science, this device combines the potential of these 3 essential factors to promote a biological effect. Using a Dark Field Electron Microscope (DFEM) to view plasma (live human blood cells) within 30 seconds of extraction, the medical professional is able to see the cell activity and multiple cellular conditions over a wide field of vision.

Some patient's exhibit thrombosis, blood platelet aggregation, the Rouleaux effect, heavy metal rings, cell wall damage and much more when their blood is viewed live in this process.

It is known that the congested red blood cell, when in aggregation or bound in cell clusters, fails to deliver essential oxygen, hydration and nutrients to all areas of the body.

A random group of patients had their blood drawn (finger sample), and viewed instantly under DFEM and was video recorded. Cell integrity issues were noticed in select patients.

Oral doses of a Nutrient Polarized Water (NPW) produced in accordance with the instant process via exposure within an ICM, were then given to these select patients, and a second blood sample was drawn (from the opposing hand) after about 2 minutes of ingesting the NPW and viewed.

Video demonstration evidence showed dramatic improvement in all subjects. Improvement included a dramatic reduction in cell cluster thrombosis. A highly visible difference in cellular lubrication and movement. These 2 main benchmark improvements are known to result in improved circulation, enable improved oxygen transportation and promote nutrient absorption.

### Experimental Results: Ionic Charge Magnetron (ICM) Reactor Device—Clinical Microscopy Study Summary

The Ionic Charge Magnetron (ICM) Reactor can influence the aqueous mineral mixture of the instant invention and facilitate rapid hydration on the cellular level. The instantly disclosed process provides a positive performance response which allows the transportation of needed oxygen and nutrients to the brain and other parts of the body to be readily called upon when necessary. Dehydration has many causes, but what is common in all situations is the loss of water and electrolytes (i.e., sodium, potassium, etc.) from the blood as well as the cells therein. The polar-activated electrolytes will cross into the red blood cells quickly and easily which will draw water back into the cells which will rehydrate, restore and protect them.

The Rouleaux Effect is a phenomenon specific to Erythrocytes, or Red Blood Cells (RBCs) wherein the RBCs form stacks visually reminiscent of “poker chips.” It is believed that the unique biconcave shape of the RBC makes it the one cell in the body that can orient in this manner. It is not fully understood as to why and is currently considered a non-specific indicator of disease. The Rouleaux effect has been associated with infections, multiple myeloma, inflammatory and connective tissue disorders, cancers, diabetes, and anemia. It also occurs when plasma protein concentration levels are high or when the ratio of RBCs to blood volume is high, both of which can occur during dehydration. The stacking effect results in a significant reduction in the available RBC surface area, that is critical to the transport of oxygen and nutrients and is essential to the normal physiologic functions in the body.

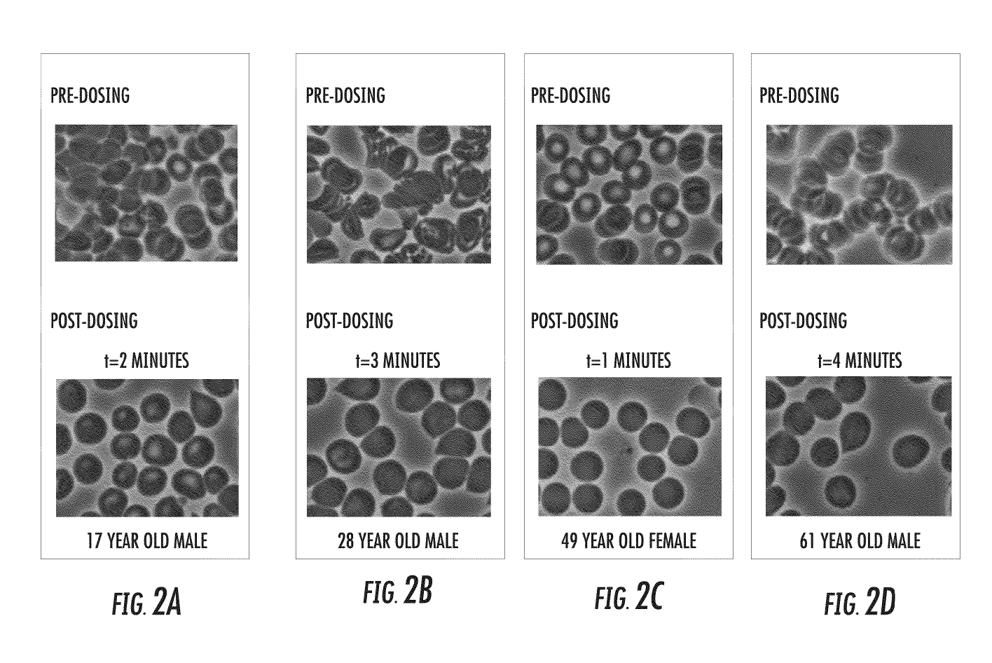

Now referring to FIGS. 2A, 2B, 2C and 2D, a study was conducted at an independent research laboratory in Naples, Florida.

The objective of this study was to confirm the effects of the Water Formulation run through the ICM Reactor and its influence on the reversing of the Rouleaux Effect after intra-oral ingestion from human test subjects.

### Trial Design and Conduct

This study was a single-center, single-group pilot study designed to confirm the effects of the 1 CM Reactor and the NPW on reversing the Rouleaux Effect.

A total of four (4) test subjects were enrolled in the study. Informed consent was not required since this data is intended for R&D purposes only. Subjects were allowed to drink mineral free water but no food or other beverages for 8 hours prior to the test. These blood samples were taken pre-dosing.

Subjects were then given the ICM influenced electrolyte formula (NPW) per the instructions (below):

1) Shake spray bottle well and then press actuator down 2 to 3 times to prime pump;

2) Spray 6 sprays into your mouth, hold for 20 seconds and then swallow.

Post-Dosing blood samples were drawn from 1 to 4 minutes after ingestion.

### Results

In all patients in the study, as illustrated by FIGS. 2A, 2B, 2C and 2D, pre-dosing micrographs reveal a profound Rouleaux effect. Within 1 to 4 minutes of ingesting the ICM influenced NPW formula, the Rouleaux effect is clearly reversed and no adverse effects or events were observed or reported.

### Conclusions

The post-dosing micrographs show an obvious improvement for all subjects. This study was successful in confirming the effectiveness of the NPW via the ICM Reactor in reversing the Rouleaux effect. The NPW produced via the ICM Reactor of the present invention does not meet with the cellular resistance and absorption challenges experienced by traditional non-charged nutrients or the oxygenated crystalloid electrolyte water formulation produced in accordance with U.S. Published Application 2011/0086135 to Mueller, et al.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention, which are obvious to those skilled in the art, are intended to be within the scope of the following claims.

What is claimed is:

1. A mineral-containing formulation which exhibits a stable negative polarity charge.

2. The mineral-containing formulation of claim 1, containing at least one mineral of the group consisting of copper, iodine, manganese, zinc, potassium, cobalt, sodium, selenium, chromium, silica, and boron.

3. The mineral-containing formulation of claim 2, wherein the amount in which each mineral may be provided, in an aqueous solution thereof, is (a) at least about 0.002 mg/l boron; (b) at least about 0.0001 mg/l chromium; (c) at least about 0.045 mg/l cobalt; (d) at least about 0.019 mg/l copper; (e) at least about 0.086 mg/l iodine; (f) at least about 0.053 mg/l manganese; (g) at least about 0.36 mg/l potassium; (h) at least about 0.0003 mg/l selenium; (i) at least about 0.029 mg/l silica; (j) at least about 2.61 mg/l sodium; and (k) at least 0.015 mg/l zinc.

4. The mineral-containing formulation of claim 3, wherein the range in which each mineral may be provided, in an aqueous solution thereof, is effective to provide boron in a minimum amount of 0.002 mg/l +/−0.4%; chromium in a minimum amount of 0.0001 mg/l +/−0.3%; cobalt in a minimum amount of 0.045 mg/l +/−0.3%; copper in a minimum amount of 0.019 mg/l +/−0.5%; iodine in a minimum amount of 0.086 mg/l +/−0.3%; manganese in a minimum amount of 0.053 mg/l +/−0.6%; potassium in a minimum amount of 0.36 mg/l +/−0.7%; selenium in a minimum amount of 0.0003 mg/l +/−0.3%; silica in a minimum amount of 0.029 mg/l +/−0.5%; sodium in a minimum amount of 2.61 mg/l +/−0.7%; and zinc in a minimum amount of 0.015 mg/l +/−0.3%.

5. A nutrient polarized water (NPW) comprising an aqueous solution containing the mineral formulation of claim 1.

6. A nutrient polarized water (NPW) comprising an aqueous solution containing the mineral formulation of claim 2.

7. A nutrient polarized water (NPW) comprising an aqueous solution containing the mineral formulation of claim 3.

8. A nutrient polarized water (NPW) comprising an aqueous solution containing the mineral formulation of claim 4.

9. A process for forming a mineral formulation which exhibits a stable negative polarity charge comprising:
providing a mineral formulation; and
exposing said mineral formulation to a magnetic field exhibiting a sufficient strength for a sufficient period of time;
whereby a mineral formulation exhibiting a stable negative polarity charge is formed.

10. The process of claim 9 wherein the mineral formulation is the formulation of claim 2.

11. The process of claim 9 wherein the mineral formulation is the formulation of claim 3.

12. The process of claim 9 wherein the mineral formulation is the formulation of claim 4.

13. A process for forming a nutrient polarized water (NPW) comprising:
providing a mineral formulation;
providing sufficient water, suitable for use in the process, to dissolve said mineral formulation;
exposing said mineral formulation as a dry blend, or in solution with said water, to a magnetic field exhibiting a sufficient strength, for a sufficient period of time, to create a stable negative polarity charge therein; and
when said mineral formulation is exposed to said magnetic field as a dry blend, subsequently dissolving said exposed mineral formulation in said sufficient suitable water as provided;
whereby a nutrient polarized water exhibiting a stable negative polarity charge is formed.

14. The process of claim 13 wherein the mineral formulation is the formulation of claim 2.

15. The process of claim 13 wherein the mineral formulation is the formulation of claim 3.

16. The process of claim 13 wherein the mineral formulation is the formulation of claim 4.

17. An ionic charge magnetron for treating a mineral formulation or an aqueous solution containing said mineral formulation so as to create a stable negative polarity charge therein, comprising:
a product flow tube, having an adjustable degree of downward slope and a longitudinal axis for transport of a mineral formulation or an aqueous solution containing said mineral formulation therethrough;
a plurality of magnets capable of exhibiting a field equivalent to about 30,000 gauss; said plurality of magnets being aligned with matching polarity and positioned at a precisely spaced separation distance D1 about said product flow line;
whereby said plurality of magnets creates an equal magnetic field extending at least a distance D2 along said product flow line;
wherein said mineral formulation or an aqueous solution containing said mineral formulation is exposed to said magnetic field for a dwell time sufficient to provide complete treatment thereof, thereby resulting in creation of a stable negative polarity charge therein.

18. The ionic charge magnetron of claim 17, wherein said magnets are Neodymium rare earth magnets having a field of 30,000 gauss.

19. The ionic charge magnetron of claim 18, wherein four neodymium magnets are provided at a separation distance D1 of 13½″, aligned with matching polarity in a Southern pole alignment configuration, which is effective to provide an equal magnetic field extending a distance D2 of at least 48″ and a dwell time of about 2.3 seconds.

20. The ionic charge magnetron of claim 17, further including stabilizers in removable engagement with said product flow tube for positioning and stabilizing said magnets about said product flow tube.

21. A process for promoting nutrient absorption and red blood cell hydration in a patient in need thereof comprising:
providing an amount of nutrient polarized water effective to result in nutrient absorption and red blood cell rehydration, produced in accordance with the method of claim 13; and
administering said nutrient polarized water to said patient;
whereby said administration results in a reversal of the Rouleaux effect.
